(19) United States
(12) Patent Application Publication
(10) Pub. No.: US 2026/0131399 A1
(43) Pub. Date: May 14, 2026

(54) LASER WELDING OF MICROFLUIDIC COMPONENTS

(71) Applicant: Parallel Fluidics, Inc., Stoneham, MA (US)

(72) Inventors: Joshua Gomes, Boston, MA (US); Duncan O'Boyle, Cambridge, MA (US)

(21) Appl. No.: 19/443,219

(22) Filed: Jan. 8, 2026

Related U.S. Application Data
(63) Continuation of application No. PCT/US24/37571, filed on Jul. 11, 2024.
(60) Provisional application No. 63/526,105, filed on Jul. 11, 2023.

(51) Int. Cl. B23K 26/00; B23K 101/04; B23K 101/34

(52) U.S. Cl. CPC B23K 26/00; B23K 2101/04; B23K 2101/34

(57) ABSTRACT

A system for laser welding microfluidic components including a first component having a boss disposed thereon, the boss raised a first distance off of the first component, wherein the boss has a chamfer circumscribing an edge of the boss, a second component having a recess disposed therein, the recess shaped to receive the boss, the recess having a first depth, wherein the first depth is less than the first distance, and a laser configured to emit a laser beam.

### CROSS-REFERENCE TO RELATED APPLICATIONS

This application is a Continuation of International Application No. PCT/US24/37571, filed on Jul. 11, 2024, which claims the benefit of U.S. Provisional Application No. 63/526,105, filed Jul. 11, 2023. The entire contents of each of these applications are hereby incorporated by reference.

### BACKGROUND OF THE DISCLOSED SUBJECT MATTER

### Field of the Disclosed Subject Matter

The disclosed subject matter relates to microfluidic chips and components. Particularly, the presently disclosed subject matter is directed to laser welding of microfluidic components.

### Description of Related Art

Microfluidic devices may comprise two or more components that are joined together to create a liquid tight assembly that enables flow within the device. At a minimum, these assemblies include a polymer film or cap that is used to seal the microfluidic channels. Various supplemental components, such as fluidic connectors, reservoirs, valves, pumps, and other functional elements may be attached to the device using a secondary assembly process. These additional components improve usability of the device or add functions that would not be possible in a single molded part.

Assembly of additional polymer components onto microfluidic devices is challenging due to requirements for biocompatibility, optical quality, liquid sealing, and other application specific demands. Typical polymer joining techniques such as ultrasonic, vibration, and spin welding create excess heat, excess melted polymer (referred to as “flash”), and particulate contamination that distort, occlude, or negatively impact microfluidic channel function. Further, these processes are highly sensitive to part design, component quality, and consistent material properties. Alternative chemical processes involving the use of solvents or adhesives can negatively impact biocompatibility of the final microfluidic device and are often limited by weld strength. In addition, many of methods for joining polymer components to microfluidic devices result in additional dead volume and features that result in poor wetting behavior. Alignment and fixturing of components to microfluidic devices can also be challenging in solvent or adhesive based bonding processes. These techniques only allow for a single, irreversible attempt at component to device alignment, creating a high-risk step in the manufacturing process.

There thus is a need for a more efficient system and method for assembly of microfluidic devices, chips and components.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a system for laser welding microfluidic components, comprising: a first component having a boss disposed thereon, the boss raised a first distance off of the first component, wherein the boss has a chamfer circumscribing an edge of the boss, a second component having a recess disposed therein, the recess shaped to receive the boss, the recess having a first depth, wherein the first depth is less than the first distance, and a laser configured to direct a laser beam to a weld surface formed where the boss contacts the recess.

In some embodiments, the first component is transmissive to the laser beam. In some embodiments, the second component is absorptive to the laser beam.

In some embodiments, the first component is absorptive to the laser beam. In some embodiments, the second component is transmissive to the laser beam.

In some embodiments, the first component and the second component are transmissive to the laser beam. In some embodiments, the system further comprises a coating disposed between the boss and the recess, the coating being absorptive to the laser beam. In some embodiments, the coating is transparent at visible wavelengths.

In some embodiments, the system further comprises a fixture, the fixture comprising: a pocket that is the shape of an outer perimeter of the second component, wherein a depth of the pocket is greater than a height of the first component and a bracket disposed at a bottom of the fixture, the bracket having at least one registration feature in the shape of a top profile of the first component.

In some embodiments, the second component further comprises a channel therethrough, and the first component further comprises a via in fluid communication with the channel.

In some embodiments, the first depth is less than a height of the first component.

In some embodiments, the first depth is greater than a height of the first component.

In some embodiments, the system further comprises a thin film cap disposed above a surface of the second component and extends across the recess.

In some embodiments, the system further comprises a fluidic layer disposed on a surface of the second component and extends across the recess.

In some embodiments, the first component further comprises a proud feature extending from a surface of the first component to the channel of the second component. In some embodiments, the second component further comprises a second recess shaped to receive the proud feature of the first component.

In some embodiments, the first component further comprises one or more independent channels and a common supply channel, the second component further comprises a channel therethrough, the one or more independent channels is in fluid communication with the common supply channel, and the one or more independent channels is in fluid communication with the channel of the second component.

In some embodiments, the recess has at least one chamfer edge.

In some embodiments, the second component is a fluidic layer.

The disclosed subject matter includes a method for laser welding microfluidic components, comprising: providing a microfluidic component having a recess, providing a component having a boss with a corresponding geometry to the recess, engaging the boss with the recess, thereby aligning the component with the microfluidic component at a weld surface, and providing a laser beam directed at the weld surface, thereby welding the component and the microfluidic component.

In some embodiments, the method for laser welding microfluidic components further comprises placing the component into a bracket with the weld surface oriented upwards, applying an optional layer made of an elastomer, soft polymer, or array of springs under the component, and using a fixture and the bracket to align the microfluidic component and the component.

In some embodiments, aligning the microfluidic component via the boss and the recess comprises aligning at least one of a tapered surface, corner radius, and clearance provided in the weld surface.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIGS. 1A-1B are perspective cross-section and orthogonal cross-section representations of an apparatus for laser welding of microfluidic components according to embodiments of the present disclosure.

FIGS. 2A-2B are exploded perspective views of a system for laser welding of microfluidic components according to embodiments of the present disclosure.

FIG. 3 is a flowchart depicting a method for laser welding microfluidic components in accordance with the disclosed subject matter.

FIGS. 4A-4D are cross-sectional views of a system for laser welding of microfluidic components in accordance with the disclosed subject matter.

FIG. 4E is a bottom view of independent liquid channels of a microfluidic component according to embodiments of the present disclosure.

### DETAILED DESCRIPTION OF EXEMPLARY EMBODIMENTS

Reference will now be made in detail to exemplary embodiments of the disclosed subject matter, examples of which are illustrated in the accompanying drawings. The method and corresponding steps of the disclosed subject matter will be described in conjunction with the detailed description of the system.

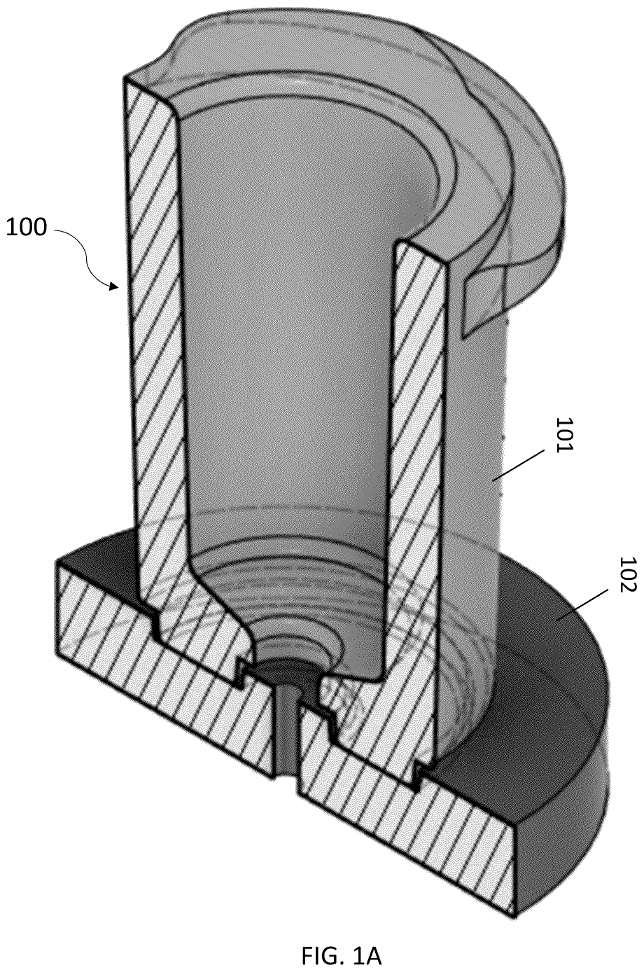

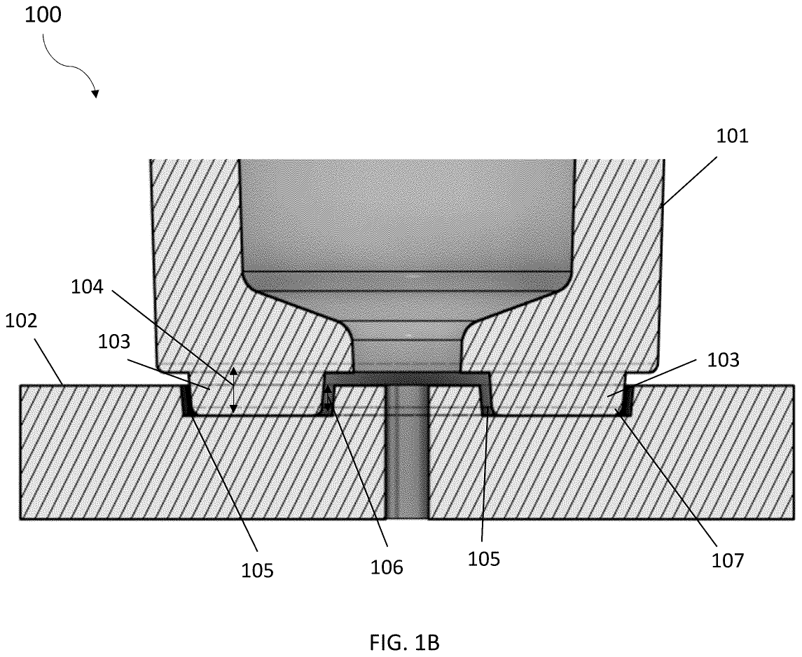

For purpose of explanation and illustration, and not limitation, an exemplary embodiment of the system in accordance with the disclosed subject matter is shown in FIGS. 1A-1B and is designated generally by reference character 100. Similar reference numerals (differentiated by the leading numeral) may be provided among the various views and Figures presented herein to denote functionally corresponding, but not necessarily identical structures.

Researchers in the life sciences industry consistently seek to manipulate fluids, cells, and molecules on ever decreasing scales to improve the precision of their experiments. This need has led to the creation of the field of Microfluidics, the study and engineering of fluid flow through channels that are geometrically constrained to features smaller than 1 millimeter in at least one dimension when viewed in cross section.

The laminar flow found at these scales gives scientists greater control of their experiments and is more representative of naturally occurring fluidic systems within organisms. Environments that previously could only be found in-vivo can now be recreated in-vitro, reducing the cost and risk associated with drug development. Additionally, microfluidic techniques can be used to combine many different laboratory processes into a single, easy-to-use, disposable device. The automation and price points afforded by microfluidic devices have transformed the diagnostic industry by allowing for near instantaneous test results directly at the point-of-care. Still, other fields like genetic sequencing, proteomics, and microbiology have all been improved through the use of microfluidic techniques.

A major factor in the success of microfluidic devices is that they can be manufactured cheaply at high volumes. Integrated designs that include not only the important microfeatures critical to flow experiments, but also reservoirs for samples, connectors, sensors, and interfaces to external instruments can be produced for a few dollars each when manufactured in thermoplastic materials at quantities in the tens of thousands, typically by injection molding. However, injection molding tooling for complex designs can cost $100,000 or more and can take months to build. Despite the improvement of flow simulation techniques in recent years, microfluidic device design is still an iterative process that can take many design cycles of physical prototypes to achieve a functional product. The time and cost associated with injection molding integrated designs force microfluidic developers to explore alternative manufacturing techniques to manufacture prototype parts quickly.

Several techniques may be used to build prototypes. One example is to cast PDMS (polydimethylsiloxane), a soft silicone rubber, onto a mold created by photolithography. A main drawback of this technique is that PDMS is not representative of the thermoplastics that most developers seek to use for a commercial product. PDMS absorbs gases and small molecules, creating unwanted variation in experiments, and its soft nature makes it less robust and more challenging to incorporate into automated instruments than hard thermoplastics. Thus, a design that works perfectly well in PDMS likely will fail if produced in thermoplastics. The discrepancy makes PDMS a poor choice for prototyping devices that will eventually become commercial products. Additionally, it is relatively simple to form the microfeatures within a PDMS prototype. However, the process is not readily compatible with forming the connectors, reservoirs, or instrument interfacing components that are often required. Thus, PDMS prototypes often need to be bonded or attached to other devices to function within a larger microfluidic system.

3D printing is an interesting prototyping technique because entirely new designs can be created in a matter of hours. The speed of the process is extremely valuable, allowing developers to iterate through different designs quickly. However, 3D printed prototypes also have severe material and process limitations. Many microfluidics applications require a clean, smooth, and inert surface within the device's microfeatures to effectively conduct their experiments. 3D printing via fused deposition modeling (FDM) creates prototypes by extruding a small bead of thermoplastic to build a device layer by layer. The layered extrusion approach yields parts that are not water resistant, have an inherently ridged surface with very poor optical properties. Additionally, FDM printers typically do not have the resolution required to create 3D microfeatures accurately. These properties make FDM printing a poor candidate for microfluidics.

3D printing via stereolithography uses an approach where a laser cures a photosensitive resin to grow the parts layer by layer. This technique offers a better surface finish than FDM, but the material limitations are significant. Optically cured materials are less inert than thermoplastics and are often compromised by solvents that are used in many microfluidic tasks. Additionally, any resin that is not fully polymerized during the curing process can contaminate experimental results. The ability to visualize processes occurring in microfeatures is also critical to many microfluidic experiments. Most photosensitive materials are opaque, rendering them useless for imaging applications, and the few available clear resins have optical properties that are subpar for microfluidic analysis. Another major drawback in any 3D printing technology is that it is difficult to accurately print enclosed channels with overhanging geometry. Many 3D printing systems are incapable of printing this type of feature without physical support structures, which are impossible to remove when inside microchannels. Despite the speed advantage, 3D printing is thus not suitable for microfluidic prototyping.

Another alternative is producing microfluidic prototypes via micromachining. A computer controlled milling machine or laser is used to subtractively produce a microfluidic device from a block or sheet of thermoplastic materials. A main advantage of this process is that the materials suitable for eventual high volume manufacturing can be used effectively. This allows the prototypes to be produced with the same material properties as the end product, a desirable result. Another advantage of this technique is that the prototype device can include the necessary external features like connectors, reservoirs, or machine interfaces to match the desired commercial end product. However, most existing machine shops are not equipped to produce the extremely small geometry required by microfluidic applications. In the case of milling, producing a 100 micron channel would require an end mill smaller than 100 microns in diameter. The small cutting tools require unique machinery and skill sets that are outside the capability of most quick turnaround machine shops. A complicated integrated design may also take multiple hours of machine time to produce via micromachining. This limits the speed with which prototypes can be produced and raises the cost of each prototype. Since most microfluidic prototypes must be disposed of after a single use, the cost and lead time associated with this method make it unsustainable. Part to part variation is also a key consideration that must be considered since the prototypes are each made sequentially.

An integrated device design often requires macro-scale features in addition to the microchannels within the microfluidic device. The large features may be necessary to accomplish tasks such as sample media storage, connection to an external pump, or integration with sensing equipment. Even if one of the above strategies is useful for producing microfeatures, it often is unable to create the additional macro features that an integrated device may require. Microfluidic technology developers may be forced to overcome this shortcoming by attaching external components after device manufacture using glue, adhesive tapes, or other techniques. Any time a new component must be bonded to a microfluidic device, there is always a risk of channel occlusion, misalignment, or contamination due to the bonding materials.

An alternative to producing integrated prototypes is to create separate, simpler devices and then connect them with tubing to create a mock integrated device. The advantage of this strategy is that the individual subsystems are often easier to prototype than a truly integrated design. However, the tubing connections between devices create additional wasted liquid volume, otherwise known as dead volume, between the subsystems and require tubing connections that are prone to failure and leaks. The inherent differences between subsystems connected via tubing and an integrated design can lead to a variety of unknowns when inevitably attempting to transition to a truly integrated design compatible with high volume manufacturing.

Sometimes, the dead volume introduced by the tubing technique is unacceptable in a microfluidic design, forcing developers to prototype individual subsystems, test them separately, and then risk producing an integrated device in high volume by injection molding without ever testing a functional integrated prototype. The assumptions necessary with this approach often result in devices that do not function properly and can lengthen project timelines when revisions inevitably need to be made, further complicating the microfluidic development process.

In addition to the fabrication problems, the typical quoting process required by prototype vendors also increases the cost and time to create microfluidic prototypes. A standard workflow for a microfluidic engineer is to design their parts, create a three dimensional computer-aided-design model (3D CAD model) or drawing, and then send the model to a vendor for a quote. The quoting process may take many back and forth conversations before a design that fits the vendor's process can be finalized, and a quote is received. This valuable lost time further impedes the iteration of the microfluidic development process and increases product cost.

As shown in FIGS. 1A-1B, a device 100 illustrating laser welding microfluidic components is shown in perspective and orthogonal cross-sectional views according to embodiments of the present disclosure. In various embodiments, the device 100 includes a first component 101 having a boss 103 disposed thereon, a second component 102 having a recess 105 disposed therein. In various embodiments, a laser (not shown) is configured to direct a laser beam (not shown) to a weld surface formed where the boss 103 contacts the recess 105. The boss is raised a first distance 104 off of the first component 101 and the boss 103 has a chamfer 107 circumscribing an edge of the boss 103. The recess 105 has a first depth 106 and is shaped and sized to receive the boss 103. The first depth 106 is less than the first distance 104.

In various embodiments, a process that is better suited to the assembly of microfluidic devices is laser welding. Laser welding involves heating polymer substrates using a controlled laser path and wavelength that is used to selectively melt and solidify a polymer interface. The process is enabled by material properties that allow for the selective transmission and absorption of the laser energy. In a typical one-micron laser process, one component is inherently transmissive to the laser wavelength (approximately 1000 nm) while the other component contains a colorant that is designed to absorb the laser energy. The laser hits the absorbing surface and melts the polymer in this area; upon cooling, the two surfaces are fused together. Alternatively, a two-micron laser process uses a wavelength (approximately 2000 nm) that is partially absorbed by the bulk polymer resulting in volumetric heating of both parts. Although these processes are established, they are not always successful in microfluidic applications. In particular, one-micron processes often require the absorbing component to be opaque which impacts imaging capabilities. Two-micron processes also are limiting because volumetric heating can lead to deformation of the fluidic channels or cap of the microfluidic device. Both processes generate significant amounts of flash when the parts are not aligned to the laser and often produce inconsistent results in heterogenous assemblies. For example, parts that use rigid and elastomeric components are difficult to weld due to a mismatch in thermal and optical properties of the materials being joined together.

The system and method of joining polymer components onto microfluidic devices that offers better control of the melted area, prevents deformation or contamination of microfluidic geometry, allows high strength polymer bonds, and produces clear welds would be a huge improvement to the scalable manufacture of polymer microfluidic devices.

A method for joining a wide variety of components onto microfluidic devices using a laser-based process that enables strong, biocompatible welds without risking microfluidic feature distortion or contamination. The process leverages a commercial laser welding system that is supported by the welded joint design, registration feature between the component and microfluidic device, and optionally by an infrared absorbing compound that transmits visible light. Further, a simple fixture design allows for rapid alignment and assembly of multiple components onto a single device. These components can comprise fluidic connectors, reservoirs, microplate wells, valves, transwell insert adapters, oxygenators, droplet generators, nozzles, flow restrictors, pressure regulators, membranes, cell culture scaffolds, and other elements that can be useful in microfluidic systems.

A method facilitates easy and rapid assembly of one or more of these components onto a microfluidic device and solves many quality control issues related to welding polymers components together. Central to the method is a mechanical joint design that facilitates easy laser alignment, concentrated pressure during the welding process, and a wide process window. The advantages of this method include the ability to control the weld displacement, amount and location of polymer flash, and optical quality of the welded joint. These methods allows the laser energy to pass through sensitive microfeatures without deformation and contamination, while ensuring the desired weld region is melted completely.

These technology improvements also enable the production of novel devices and multi-component assemblies that would not be practical using other methods. This is possible due to defined welded areas that offer high strength and consistent bonds. These methods also allows for the assembly of multi-material components and sub-assemblies that contain captive components such as diaphragms and membranes that are compressed and sealed against the microfluidic chip. Because these members are not welded directly, they do not need to exhibit the same thermal properties or chemical compatibility to be successfully attached to the device. This method limits the amount of heat applied to the diaphragm or membrane and protects it from thermal distortion or unwanted adhesion to other surfaces of the microfluidic device. Further, it offers better strength than would be possible by welding the membrane or diaphragm directly, especially for difficult to weld polymers such as PTFE or PMP. Additionally, these techniques allows for simple and reversible alignment of components to the microfluidic device before the laser welding process occurs. This is a lower risk assembly technique that ensures proper alignment, as opposed to adhesive or solvent based techniques. It also enables future incorporation of “pick and place” robotic systems to further automate the production process.

In various embodiments, an advantageous feature of the laser process is a raised surface or boss 103 on the component that localizes the melted material to a single surface and allows for some misalignment of the laser to the part. The raised surface is wide enough to provide a strong welded area but small enough that it is easy to provide pressure over the entire area. In a preferred configuration, the raised surface is drafted and features a small chamfer or corner radius that makes the component easier to injection mold and helps align the component to the microfluidic device. This feature also adds space for excess melted material to displace into and allows for some misalignment of the laser because it limits the production of flash generated at the perimeter of the weld. The raised boss 103 fits into a recess 105 on the microfluidic device that provides for alignment of the component and helps contain any flash generated by the welding process. The recess can have more clearance in the center of a round weld joint because flash is more problematic at the center of the weld; this is due to its proximity to the liquid channels and disproportionately low volume for flash to escape into at the center of the weld.

In one configuration, the microfluidic device is transmissive to laser energy and the component to be welded is absorptive. In an alternative configuration, the microfluidic device is absorptive and the component to be welded is transmissive. In a final configuration, both the microfluidic device and component are transmissive, and a laser absorbing coating and/or additive is applied at the joint geometry between the two transmissive bodies. A selectively placed additive offers precise control over the welded area and minimizes the amount of heated material and flash. In a preferred embodiment, the coating is transmissive to visible light and only absorbs light at or near the laser wavelength. This allows the weld to be optically clear for imaging applications and allows for a user or operator to see the liquid inside of the microfluidic channels. The coating can be applied using a variety of methods such as a stamping process, masked spray coating, automated liquid dispensing method (such as pipette or inkjet), pen, or vapor deposition process. For most components, a simple stamp can be used that wicks a small volume of a liquid-based coating onto the mating surface of the part. The wicking behavior can be generated using a fabric, foam, or porous material such as a sintered metal or ceramic. The wicking action can be restricted using a porous surface in the shape of the welded area so that the coating does not get applied to undesirable surfaces and so that a consistent amount of coating is applied to each part. After welding, any discoloration of the welded surface caused by the coating can be reduced by exposing the part to a targeted wavelength of light or by a thermal heat treatment using an oven or other heating process. The preferred coating and/or additive is certified for biocompatibility to prevent negative effects on biological experiments. In various embodiments, the coating can be applied to the components at the intended weld surface. In various embodiments, the additive can be applied in the fabrication of the components themselves or applied to the surface or within the body of the components at the weld surface or proximate thereto.

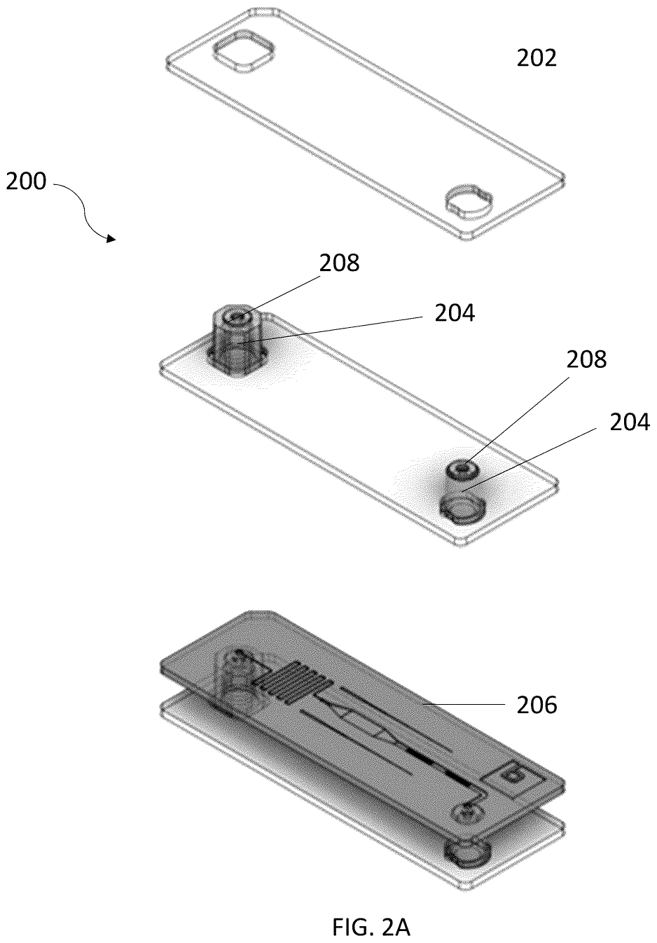

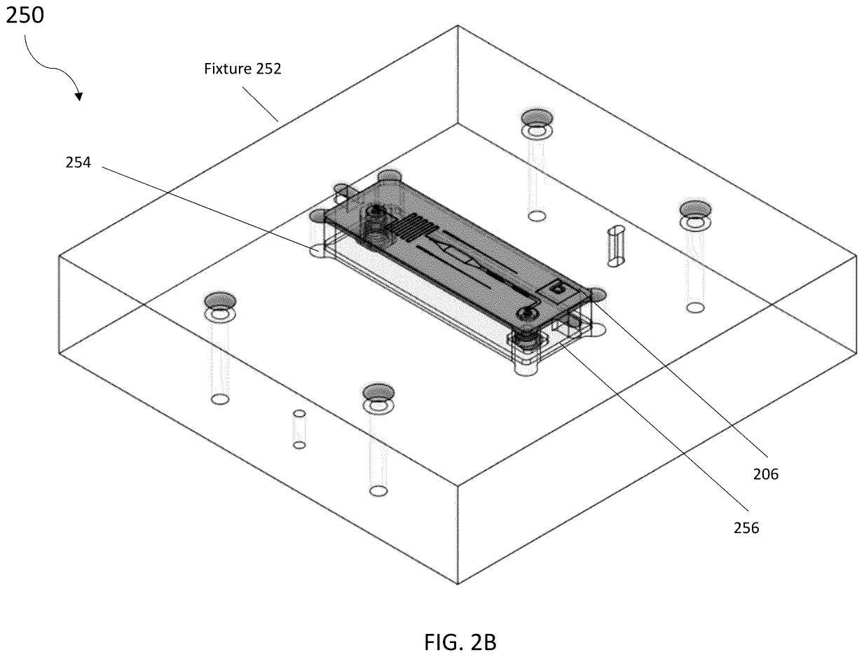

Referring to FIGS. 2A and 2B, an exploded view 200 and perspective view 250 of a fixture for laser welding microfluidic components are shown. One or more components 204 can be attached to a microfluidic device 206 in a single fixture 252 and in a single laser process. The fixture 252 comprises a pocket 254 that is the shape of the outer perimeter of the microfluidic device 206 that is slightly deeper than the tallest component that is to be welded. A thin bracket 202 is placed at the bottom of the fixture 252 that contains registration features in the shape of the top profile of the components 204 to be attached to the microfluidic device 206. The components 204 are placed into the bracket 202 with the welded surface 208 oriented upwards. An optional layer (not shown) made of an elastomer, soft polymer, or array of springs can be placed under the components 204. The microfluidic device 206 is then aligned to the pocket 254 of the fixture 252 with the cap oriented upwards and placed on top of the components 204. The mating recess on the microfluidic device 206 automatically aligns to the components 204 due to the tapered surface, corner radius, and clearance provided in the joint.

A variety of novel components are also enabled by this process according to embodiments of the present disclosure. In one application, a multi-well microplate geometry can be attached to a microfluidic chip so that channels can be connected to standard well geometry. The component comprising an array of open bottom wells that are attached to a frame that matches the ANSI/SLAS standard for a multi-well plate. The open bottom wells contain a similar raised surface that localizes pressure during the welding process and contains flash produced during the welding process. The multi-well plate can be opaque or coated with an infrared absorbing compound.

Diaphragms and membranes can also be included in the attached components due to the controlled displacement of the welded area. These features can include elastomeric parts such as pump or valve diaphragms, membranes used for gas exchange and venting, or cell culture scaffolds. During the laser process, the softer component is held captive by a rigid component and is clamped or compressed during the welding process to create a seal against the microfluidic chip. A raised bump or sharp surface on the microfluidic chip can be used to guarantee a strong seal and allow for more practical tolerances in the component assembly. The laser selectively melts a rigid polymer interface on the component to provide a low-displacement and high strength bond. During cooling, the membrane or diaphragm is still compressed so that it remains sealed to the microfluidic chip after the welding process.

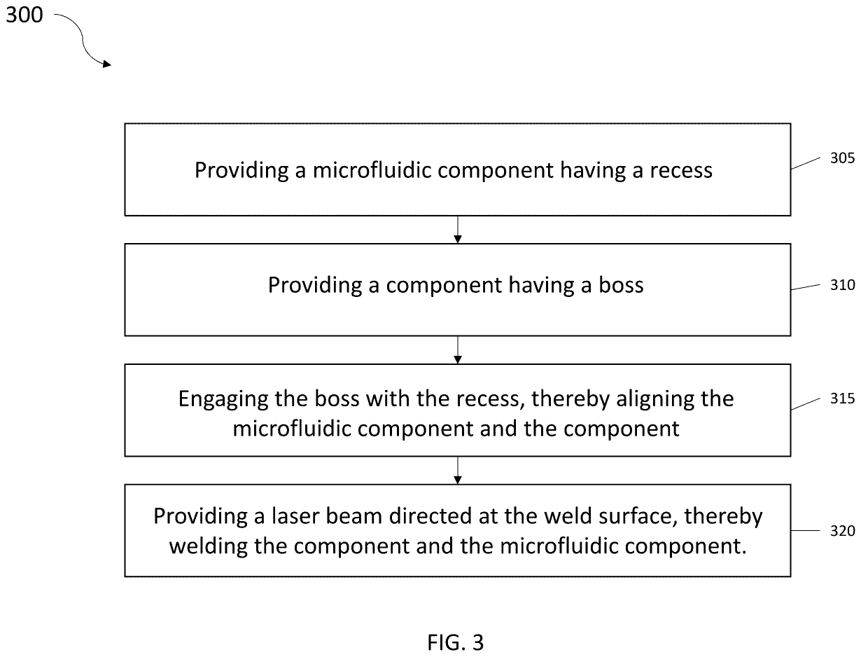

FIG. 3 is a flowchart of a method 300 for laser welding microfluidic components according to embodiments of the present disclosure. Method 300 for laser welding microfluidic components, including, at step 305, providing a microfluidic component having a recess.

Method 300 includes, at step 310, providing a component having a boss with a corresponding geometry to the recess as disclosed herein above.

Method 300 includes, at step 315, engaging the boss with the recess, thereby aligning the component with the microfluidic component at a weld surface. Engaging the boss with the recess can include, in various embodiments, placing the component into a bracket with the weld surface oriented upwards, applying an optional layer made of an elastomer, soft polymer, or array of springs under the component and aligning the microfluidic component to the fixture with the cap oriented upwards and placed on top of the component, wherein the boss and the recess align to the components. In various embodiments, aligning the microfluidic component via the boss and the recess comprises aligning at least one of a tapered surface, corner radius, and clearance provided in the weld surface.

Method 300 includes, at step 320, providing a laser beam directed at the weld surface, thereby welding the component and the microfluidic component.

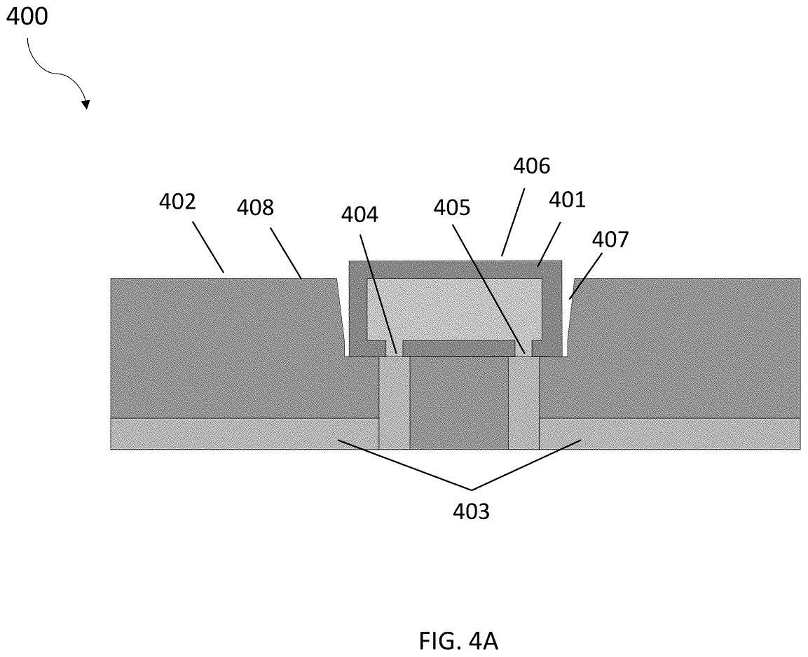

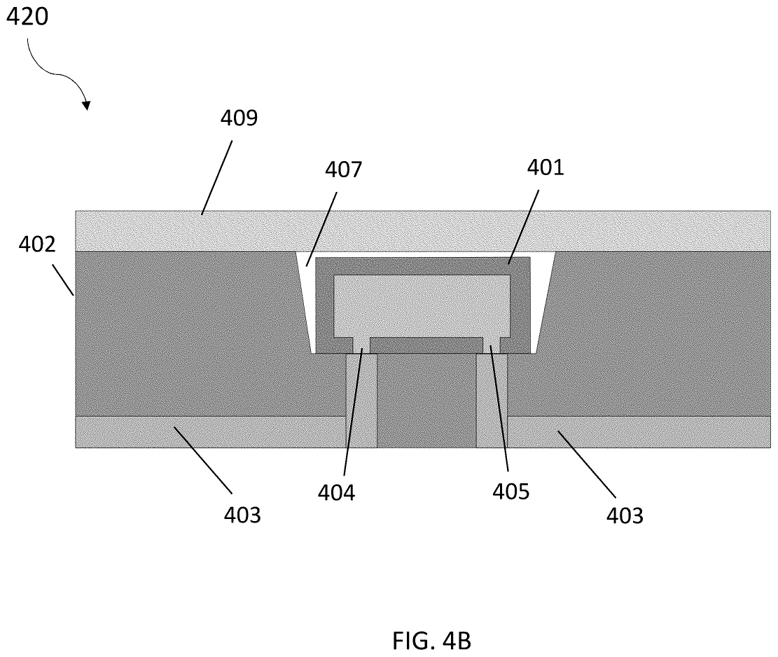

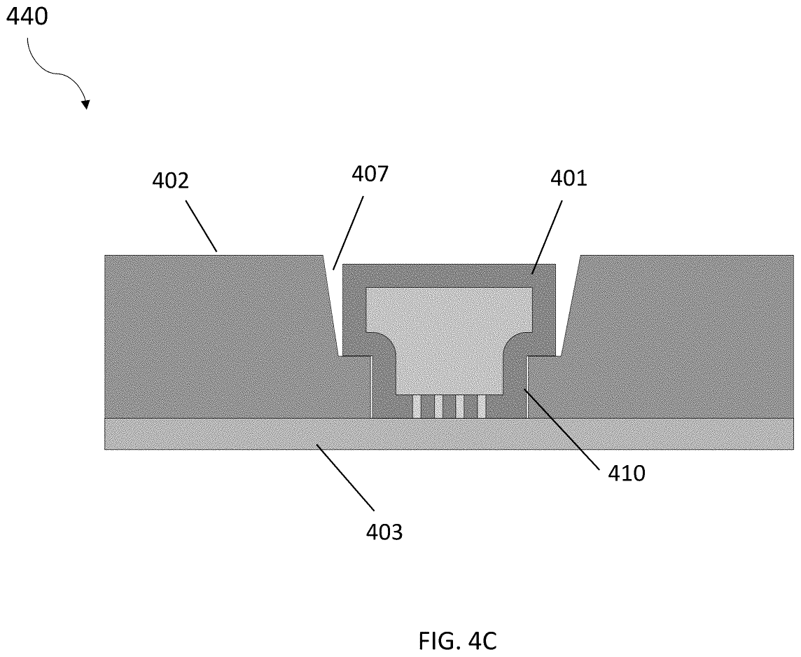

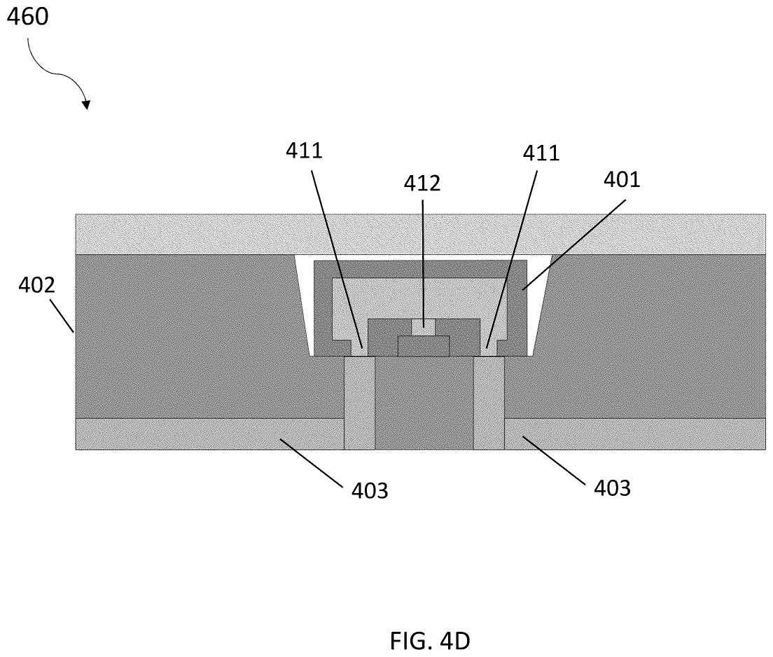

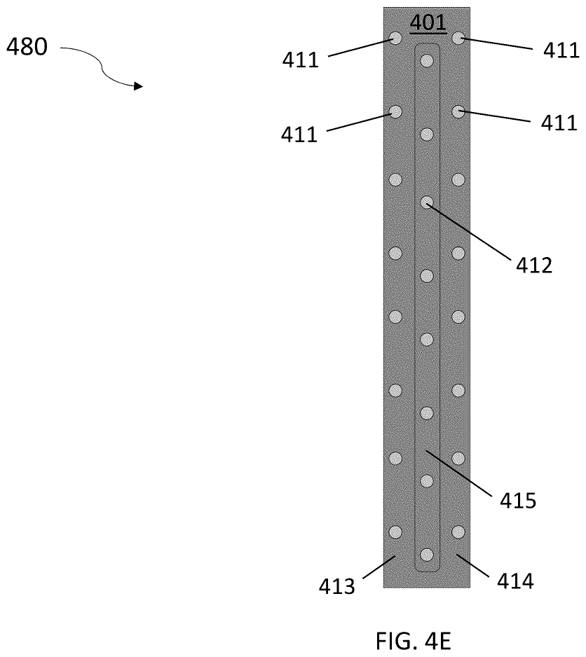

FIG. 4A is a diagram 400 illustrating a cross-sectional view of a system for laser welding microfluidic components according to embodiments of the present disclosure. In various embodiments, microfluidic components can also include internal channels, membranes, filters, elastomers, electrodes, or other features to enable their desired functionality. A fully encapsulated component 401 as shown in FIG. 4A can be beneficial because it provides a thermal insulation barrier between the weld surface and the interior of the component and a physical barrier to prevent damage during assembly and minimize exposure to contaminants. Additionally, a fully encapsulated design can reduce the risk of component fouling due to variations in the laser welding process.

In various embodiments, liquid can flow from channels 403 of the fluidic layer 402 into one or more input vias 404, through the component 401, and then out one or more outlet vias 405 back into the fluidic layer 402. In various embodiments, liquid can only pass in one direction, from the fluidic layer into the component, or vice versa. Embedded components can be thinner than the microfluidic device body and can be a few millimeters or smaller in X-Y footprint.

For thin components, the component 401 can drop into the fluidic layer 402 (i.e., the main body of the microfluidic device) as shown in FIG. 4A. A recess 407 can be molded or otherwise formed into the device body. The recess 407 can have a taper angle to assist with component insertion. An exterior surface or feature on the component 401 can align the component with the fluidic layer 402. A compressive load can then be applied to the component and a laser can be used to weld the base of the component to the face of the recess in the fluidic layer. This type of assembly is compatible with existing pick-and-place machinery used in other industries. A compressive load can be applied after assembly and a laser can be used to create a strong, leak-free bond between the fluidic layer and the component.

The vias 404, 405 in the component can be sized larger or smaller than the channels 403 of the fluidic layer 402 by an amount greater than or equal to the expected alignment tolerance between the component 401 and the fluidic layer 402 to prevent unwanted flow constrictions and promote complete wetting of the microfeatures within the component and the fluidic layer. In some embodiments, the top surface 406 of the component 401 is proud. In various embodiments, a surface is proud when it is protruding from the surrounding surface) relative to the surface 408 of the fluidic layer 402 as shown in FIG. 4A.

FIG. 4B is a diagram 420 illustrating a cross-sectional view of a system for laser welding microfluidic components according to embodiments of the present disclosure. FIG. 4B illustrates the recess 407 having a depth larger than the total height of the component 401. This configuration allows for the installation of a surface 409 such as a thin film cap, another fluidic layer, or any other part disposed on the top surface of the fluidic layer without interfering with the component functionality. This assembly method can allow for multi-layer devices with liquid communication between components residing on different fluidic layers.

FIG. 4C is a diagram 440 illustrating a cross-section view of a system for laser welding microfluidic components according to embodiments of the present disclosure. FIG. 4C illustrates various embodiments where a component 401 drops into a recess 407, with a proud feature 410 (e.g., protruding from the surrounding surface) extending a distance from the bottom surface of the component 401 to an exposed channel 403 within the fluidic layer 402. The laser weld can isolate the top surface of the component from the liquid flow while the bottom surface of the component is in contact with an exposed channel within the microfluidic device. In various embodiments, this configuration allows integration of electrodes, sensors, or any other component where direct contact between the face of the component and the liquid flow front within the fluidic layer is required.

FIG. 4D is a diagram 460 illustrating a cross-sectional view of a system for laser welding microfluidic components according to embodiments of the present disclosure. FIG. 4D illustrates various embodiments where several independent channels 411 within a single component 401 can be controlled or serviced by a common supply channel 412. FIG. 4D illustrates the cross-section of one independent liquid channel 411 in the component 401.

FIG. 4E is a diagram 480 illustrating a bottom view of 8 independent liquid channels 411 that flow from left to right, and a common central supply channel 415 running vertically in the center of the component 401 according to embodiments of the present disclosure. In various embodiments, the first column 413 and third column 414 of vias 411 in FIG. 4E are all isolated from each other by a single laser-welded surface on the base of the component. In various embodiments, the surface surrounding the vias 412 in the central column 415 is not laser welded, creating a liquid or air communication pathway between each central via in the component. There can be any number of isolated liquid channels within the component supplied by the same central via channel. In various embodiments, the common channel can be routed in a different location within the component.

The various embodiments illustrated by FIG. 4D and FIG. 4E can be useful for applications that require simultaneous control of independent channels. For example, it can supply pressure to multiple air-actuated valves simultaneously, which eliminates the need for supply routing channels within the fluidic layer or external tube routing.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A system for laser welding microfluidic components, comprising:
a first component having a boss disposed thereon, the boss raised a first distance off of the first component, wherein the boss has a chamfer circumscribing an edge of the boss;
a second component having a recess disposed therein, the recess shaped to receive the boss, the recess having a first depth, wherein the first depth is less than the first distance; and
a laser configured to direct a laser beam to a weld surface formed where the boss contacts the recess.

2. The system of claim 1, wherein the first component is transmissive to the laser beam.

3. The system of claim 2, wherein the second component is absorptive to the laser beam.

4. The system of claim 1, wherein the first component is absorptive to the laser beam.

5. The system of claim 4, wherein the second component is transmissive to the laser beam.

6. The system of claim 1, wherein the first component and the second component are transmissive to the laser beam.

7. The system of claim 6, further comprising a coating disposed between the boss and the recess, the coating being absorptive to the laser beam.

8. The system of claim 7, wherein the coating is transparent at visible wavelengths.

9. The system of claim 1, further comprising a fixture, the fixture comprising:
a pocket that is the shape of an outer perimeter of the second component, wherein a depth of the pocket is greater than a height of the first component and
a bracket disposed at a bottom of the fixture, the bracket having at least one registration feature in the shape of a top profile of the first component.

10. The system of claim 1, wherein:
the second component further comprises a channel therethrough, and
the first component further comprises a via in fluid communication with the channel.

11. The system of claim 1, wherein the first depth is less than a height of the first component.

12. The system of claim 1, wherein the first depth is greater than a height of the first component.

13. The system of claim 12, further comprising:
a thin film cap disposed above a surface of the second component and extends across the recess.

14. The system of claim 12, further comprising:
a fluidic layer disposed on a surface of the second component and extends across the recess.

15. The system of claim 10, wherein
the first component further comprises a proud feature extending from a surface of the first component to the channel of the second component.

16. The system of claim 15, wherein:
the second component further comprises a second recess shaped to receive the proud feature of the first component.

17. The system of claim 1, wherein:
the first component further comprises one or more independent channels and a common supply channel,
the second component further comprises a channel therethrough,
the one or more independent channels is in fluid communication with the common supply channel, and
the one or more independent channels is in fluid communication with the channel of the second component.

18. The system of claim 1, wherein
the recess having at least one chamfer edge.

19. The system of claim 1, wherein the second component is a fluidic layer.

20. A method for laser welding microfluidic components, comprising:
providing a microfluidic component having a recess;
providing a component having a boss with a corresponding geometry to the recess;
engaging the boss with the recess, thereby aligning the component with the microfluidic component at a weld surface; and
providing a laser beam directed at the weld surface, thereby welding the component and the microfluidic component.

21. The method of claim 20, further comprising
placing the component into a bracket with the weld surface oriented upwards;
applying an optional layer made of an elastomer, soft polymer, or array of springs under the component; and
using a fixture and the bracket to align the microfluidic component and the component.

22. The method of claim 20, wherein aligning the microfluidic component via the boss and the recess comprises aligning at least one of a tapered surface, corner radius, and clearance provided in the weld surface.
